(19) United States
(12) Patent Application Publication
(10) Pub. No.: US 2008/0250431 A1
(43) Pub. Date: Oct. 9, 2008

(54) SYSTEM AND METHOD FOR DISPLAYING MEDIA FILES IN A MEDIA APPLICATION FOR A PORTABLE MEDIA DEVICE

(75) Inventors: Matthew Lee, Belleville (CA); Andrew James Turcotte, Stittsville (CA); Samer Fahmy, Waterloo (CA); Andrew Douglas Bocking, Waterloo (CA); Michael Thomas Hardy, Waterloo (CA); Alen Mujkic, Mississauga (CA)

Correspondence Address: OGILVY RENAULT LLP, 1981 MCGILL COLLEGE AVENUE, SUITE 1600, MONTREAL, QC, H3A2Y3, CA

(73) Assignee: RESEARCH IN MOTION LIMITED, Waterloo, ON (CA)

(21) Appl. No.: 11/696,259

(22) Filed: Apr. 4, 2007

(51) Int. Cl. G06F 3/00

(52) U.S. Cl. 719/328

(57) ABSTRACT

A method is provided for use with a media application running on a wireless device. The method displays to a user a listing of media files available in a memory of the wireless device. The method comprises the steps of: determining locations in the memory to search for the available media files; the locations including all memory devices of the wireless device suitable for storing the media flies except for one or more predetermined folders contained in the memory, searching the determined locations for files to include in the listing of available media files; locating files not yet included in the listing of available media files; determining if the located files meet criteria of the search and identifying located files that meet the criteria of the search as suitable media files, and displaying a menu including the suitable media files.

### TECHNICAL FIELD

The present disclosure relates generally to portable devices; and more particularly to a system and method for displaying media files in a media application for a portable media device.

### BACKGROUND

Users of media applications on personal computers and wireless devices are accustomed to using play lists organized by the media applications to organize collections of music files that they wish to listen to. Users must perform numerous functions within the media application, many of which operate on those play lists. Users may also view and/or listen to collections of media stored on the wireless device without the use of play lists. Portable devices have a fairly limited amount of screen space and battery power. Therefore, if media applications on portable devices are inefficient because the media applications (a) perform functions in a way that the user does not wish, (b) use valuable screen space to show the user items he does not need to see, or (c) require the user to perform extra steps that are not necessary to achieve a particular task, the experience of using the portable device is detracted from. This wastes the user's time and also uses unnecessary computing resources on the wireless device such as processing and battery power, as well as on the desktop computer.

Accordingly, it would be desirable to have a system and method for handling media files for a portable media device that serves to provide a more user friendly interface for users of media applications, such that media on the portable device can be quickly and efficiently managed and is presented to the user in a way that is closer to what the typical user expects. It would be desirable to have a system and method for managing media for a portable media device that shows the user only what he wishes to see at any particular time.

### BRIEF DESCRIPTION OF THE DRAWINGS

Reference will now be made to the drawings, which show by way of examples embodiments of the present disclosure, and in which:

FIG. 1 shows in block diagram form a wireless device suitable for running a media application in accordance with one embodiment;

FIG. 2 shows in block diagram form a communication system suitable for providing the operating environment of the wireless device of FIG. 1 in accordance with one embodiment;

FIG. 3 shows in block diagram form the contents of a memory of the wireless device of FIG. 1;

FIG. 4 is a front view illustrating the wireless device of FIG. 1;

FIG. 5 shows a block diagram of an example computer system that hosts a media management application for use with the wireless device of FIG. 1;

FIGS. 6a and 6b are diagrams illustrating screen images of a media player application in accordance with one embodiment;

FIGS. 7a and 7B are diagrams illustrating screen images of a media player application in accordance with another embodiment; and

FIG. 8 is a flowchart illustrating a method of displaying media files in accordance with one embodiment.

It will be noted that throughout the appended drawings, like features are identified by like reference numerals.

### DETAILED DESCRIPTION

One aspect of the application provides a method for use with a media application running on a wireless device. The method displays to a user a listing of media files available in a memory of the wireless device. The method comprises the steps of: determining locations in the memory to search the available media files, the locations including all memory devices of the wireless device suitable for storing the media files excluding one or more predetermined folders contained in the memory; searching the determined locations for files to include in the listing of available media files; locating files not already included in the listing of available media files, determining if the located files meet one or more defined criteria of the search and identifying the located files that meet the defined criteria of the search as suitable media files; and displaying a menu listing the available media files.

Another aspect of the application provides a wireless device for displaying to a user a listing of media files available in a memory of the wireless device. The wireless device comprises a microprocessor for controlling operation of the wireless device; a first input device coupled to the microprocessor for accepting an input from a user of the wireless device; a display device coupled to the microprocessor. For communicating an output to the user; a communications subsystem coupled to the microprocessor for communicating with a communications network; and a memory coupled to the microprocessor. The wireless device includes a media application module resident in the memory for execution by the microprocessor The memory has media files stored therein. The media application module is configured to determine locations in the memory to search for the available media files, the locations including all memory devices of the wireless device suitable for storing the media files excluding one or more predetermined folders contained in the memory; search the determined locations for flies to include in the listing of available media files: locate files not yet included In the listing of available media files determine if the located files meet criteria of the search and identifying located files that meet the one or more defined criteria of the search as suitable media files; and display a menu listing the available media files.

Another aspect of the application provides a computer program product having a computer readable medium tangibly embodying code for displaying to a user a listing of media files available in a memory of a wireless device. The wireless device includes a media application running on the wireless device. The computer program product includes: code for determining locations in the memory to search for the available media files, the locations including all memory devices of the wireless device suitable for storing the media files excluding one or more predetermined folders contained in the memory; code for searching the determined locations for files to include in the listing of available media files; code for locating files not yet included in the listing of available media files, code for determining if the located files meet criteria of the search and identifying located files that meet the criteria of the search as suitable media files, and code for displaying a menu listing the available media files.

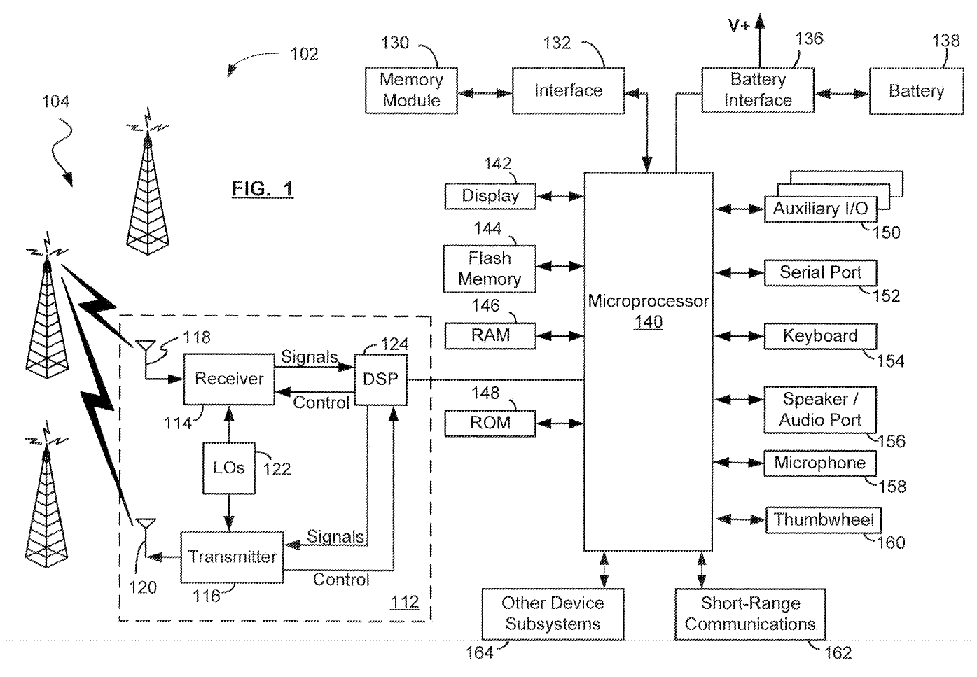

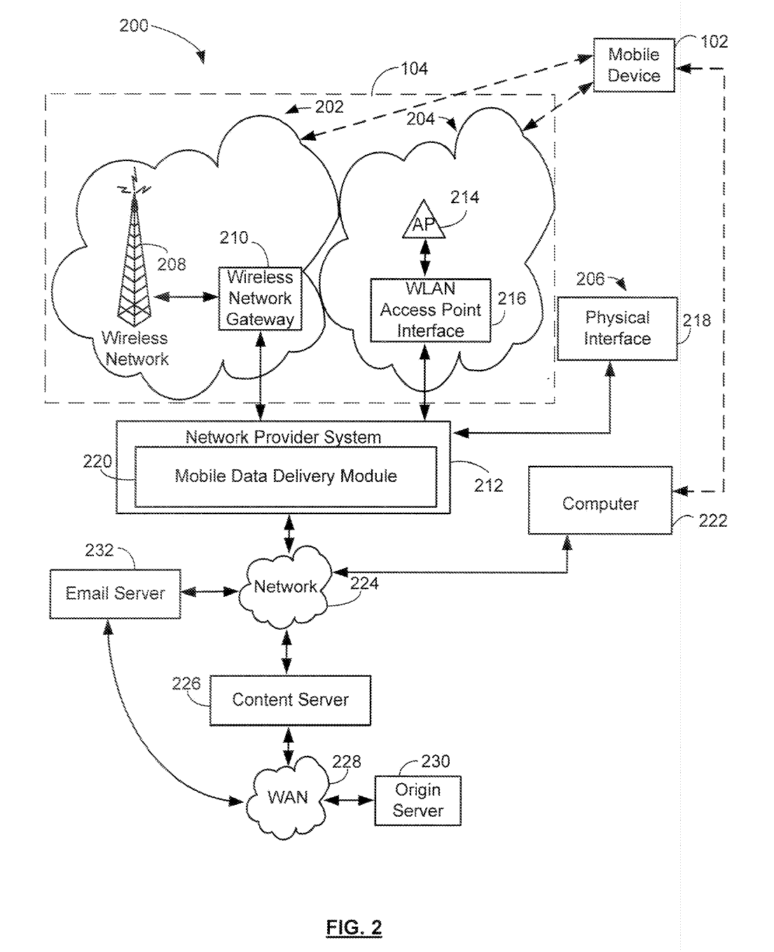

Reference is first made to FIG. 1, which shows a block diagram illustrating a portable wireless device 102 suitable or running a media player application in accordance with one embodiment of the present disclosure. The wireless device 102 communicates through a wireless communication network 104. The wireless network 104 includes antenna, base stations; and supporting radio equipment as for supporting wireless communications between the wireless device 102 and other devices connected to wireless network 104. The wireless network 104 may be coupled to a wireless network gateway and to a wide area network; shown in FIG. 2.

In one embodiment, the wireless device 102 Is a two-way communication device having at least voice and data communication capabilities including the capability to communicate with other computer systems. In one embodiment, the wireless device 102 is a handheld device. Depending on the functionality provided by the wireless device 102, it may be referred to as a data messaging device, a two-way pager, a cellular telephone with data messaging capabilities, a wireless Internet appliance, a data communication device (with or without telephony capabilities), or a portable media or music player. The wireless device 102 may communicate with any one of a plurality of fixed transceiver stations within its geographic coverage area,

The wireless device 102 may incorporate a communication subsystem 112, which includes a receiver 114, a transmitter 116, and associated components, such as one or more antenna elements 118 and 120, local oscillators (LOs) 122, and a processing module such as a digital signal processor (DSP) 124. In one embodiment, the antenna elements 118 and 120 may be embedded or internal to the wireless device 102. As will be apparent to those skilled in the field of communications, the particular design of the communication subsystem 112 depends on the wireless network 104 in which the wireless device 102 is intended to operate.

The wireless device 102 may send and receive communication signals over the wireless network 104 after the required network registration or activation procedures have been completed. Signals received by the antenna 118 through the wireless network 104 are input to the receiver 114, which may perform such common receiver functions as signal amplification, frequency down conversion, filtering, channel selection, etc., as well as analog-to-digital (A/D) conversion A/D conversion of a received signal allows more complex communication functions such as demodulation and decoding to be performed in the DSP 124. In a similar manner, signals to be transmitted are processed, including modification and encoding, for example, by the DSP 124. These DSP-processed signals are input to the transmitter 116 for digital-to-analog (D/A) conversion, frequency up conversion, filtering, amplification, and transmission to the wireless network 104 via the antenna 120. The DSP 124 not only processes communication signals, but also provides for receiver and transmitter control. For example, the gains applied to communication signals in the receiver 114 and the transmitter 116 may be adaptively controlled through automatic gain control algorithms implemented in the DSP 124.

Network access is associated with a subscriber or user of the wireless device 102 via a memory module, such as a memory module 130, which may be a Subscriber Identity Module (SIM) card for use in a GSM network or a USIM card for use in a UMTS. The SIM card is inserted in or connected to an interface 132 of the wireless device 102 in order to operate in conjunction with the wireless network 104. Alternatively, the wireless device 102 may have an integrated identity module for use with systems such as Code Division Multiple Access (CDMA) systems.

The wireless device 102 also includes a battery interface 136 for receiving one or more rechargeable batteries 138. The battery 138 provides electrical power to at least some of the electrical circuitry in the wireless device 102, and the battery interface 136 provides a mechanical and electrical connection for the battery 138. The battery interface 136 is coupled to a regulator (not shown) which provides power V+ to the circuitry of the wireless device 102.

The wireless device 102 includes a microprocessor 140 which controls the overall operation of the wireless device 102. Communication functions, including at least data and voice communications, are performed through the communication subsystem 112. The microprocessor 140 also interacts with additional device subsystems such as a display 142, a flash memory 144, a random access memory (RAM) 146, a read-only memory (ROM) 148, auxiliary input/output (I/O) subsystems 150, a data port such as serial port 152; a keyboard or keypad 154, a speaker or audio port 156 for connecting to, for example a set of headphones, a microphone 158, a clickable thumbwheel or thumbwheel 160, a short-range communications subsystem 162, and any other device subsystems generally designated as 164. Some of the subsystems shown In FIG. 1 perform communication-related functions whereas other subsystems may provide “resident” or on-device functions. Notably, some subsystems, such as the keypad 154, the display 142, and the clickable thumbwheel 160, for example, may be used for both communication-related functions, such as entering a text message for transmission over the wireless network 104, and executing device-resident functions such as a calculator or task list. Operating system software used by the microprocessor 140 is preferably stored in a persistent store such as the flash memory 144, which may alternatively be the ROM 148 or similar storage element Those skilled in the art will appreciate that the operating system, specific device applications, or parts thereof, may be temporarily loaded into a volatile store such as the RAM 146

The microprocessor 140, in addition to its operating system functions, enables execution of software applications on the wireless device 102. A predetermined set of applications that control basic device operations, including data and voice communication applications, will normally be installed on the wireless device 102 during or after manufacture. The wireless device 102 may include a personal information manager (PIM) application having the ability to organize and manage data items relating to a user such as, but not limited to, instant messaging, email calendar events, voice mails, appointments, and task items. The wireless device 102 may also include a media player application for playing media files such as video flies (e.g., .VOB, .AVI, .WMV, or .MPG), audio files (e,g., .P2, .MP3, .MP4, .AAC, .WAV), or any other type of media file known to those skilled in the art. Naturally, one or more memory stores are available on the wireless device 102 to facilitate storage of media file data items and other information, such as the flash memory 144, the RAM 146, the ROM 148, the memory module 130, or other types of memory storage devices or FLASH memory cards represented by the other device subsystems 164, such as Secure Digital (SD) cards or mini-SD cards, etc.

The PIN and/or media applications have the ability to send and receive data items via either the wireless network 104 or a link to a computer system. The link to the computer system may be via the serial port 152 or the short range communications subsystem 162. In one embodiment, PIM and/or media data items are seamlessly combined, synchronized, and updated via the wireless network 104, with the wireless device user's corresponding data items stored and/or associated with a host computer system thereby creating a mirrored or partially mirrored host computer on the wireless device 102 with respect to such items. This is advantageous where the host computer system, the wireless device user's office computer system. Additional applications may also be loaded onto the wireless device 102 through the wireless network 104, the auxiliary I/O subsystem 150, the serial port 152, the short-range communications subsystem 162, or any other suitable subsystem 164, and installed by a user in the RAM 146 or a non-volatile store such as the ROM 148 for execution by the microprocessor 140. Such flexibility in application installation increases the functionality of the wireless device 102 and may provide enhanced on-device functions, communication-related functions, or both. For example, secure communication applications may enable electronic commerce functions and other such financial transactions to be performed using the wireless device 102.

In a data communication mode, a received data signal representing information such as a text message, an email message, a media file to be transferred, or Web page download will be processed by the communication subsystem 112 and input to the microprocessor 140. The microprocessor 140 will further process the signal for output to the display 142 or alternatively to the auxiliary I/O device 150. A user of the wireless device 102 may also compose data items, such as email messages, for example, using the keypad 54 and/or the clickable thumbwheel 160 in conjunction with the display 142 and possibly the auxiliary I/O device 150. The keypad 154 may be either a complete alphanumeric keypad or telephone-type keypad. These composed items may be transmitted through the communication subsystem 112 over the wireless network 104 or via the short range communication subsystem 162.

For voice communications, the overall operation of the wireless device 102 is similar, except that the received signals would be output to the speaker or audio port 156 and signals for transmission would be generated by a transducer such as the microphone 158. Alternative voice or audio I/O subsystems, such as a voice message recording subsystem, may also be implemented on the wireless device 102. Although voice or audio signal output is typically accomplished primarily through the speaker or audio port 156, the display 142 may also be used to provide an indication of the identity of a calling party, duration of a voice call, or other voice call related information. Stereo headphones may also be used in place of the speaker 156.

The serial port 152 is normally implemented in a personal digital assistant (PDA) type communication device for which synchronization with a user's computer is a desirable, albeit optional, component. The serial port 152 enables a user to set preferences through an external device or software application and extends the capabilities of the wireless device 102 by providing for information, media file, or software downloads to the wireless device 102 other than through the wireless network 104. The alternate download path may, for example, be used to load media files onto the wireless device 102 through a direct, reliable and trusted connection to thereby provide the user of the device 102 with media files to view and/or listen to using a media application of the device 102.

The short-range communications subsystem 162 is an additional optional component which provides for communication between the wireless device 102 and different systems or devices, which need not necessarily be similar devices. For example, the subsystem 162 may include an infrared device and associated circuits and components, or a wireless bus protocol compliant communication mechanism such as a Bluetooth™ communication module to provide for communication with similarly-enabled systems and devices (Bluetooth™ is a registered trademark of Bluetooth SIG, Inc.). In another embodiment, the short-range communications subsystem 162 may be a wireless networking communications subsystem, conforming to IEEE 802.11 standards such as 802.11b and/or 802.11g.

Reference is next made to FIG. 2, which shows a communication system 200 suitable for use with the wireless device 102 shown n FIG. 1. The communication system 200 generally includes one or more wireless devices 102 (only one of which is shown in FIG. 2) and the wireless network 104. The wireless network 104 may include a wireless Wide Area Network (WAN) 202, a Wireless Local Area Network (WLAN) 204, and/or other interfaces 206 (which may not necessarily be wireless).

Referring to FIG. 2, the wireless WAN 202 may be implemented as a packet-based cellular or mobile network that includes a number of base stations 208 (one of which is shown in FIG. 2) where each of the base stations 208 provides wireless Radio Frequency (RF) coverage to a corresponding area or cell. The wireless WAN 202 is typically operated by a cellular network service provider that sells subscription packages to users of the wireless devices 102. The wireless WAN 202 comprises a number of different types of networks, for example, Mobitex Radio Network, DataTAC, GSM (Global System for Mobile Communication), GPRS (General Packet Radio System), TDMA (Time Division Multiple Access);, CDMA (Code Division Multiple Access), CDPD (Cellular Digital Packet Data), iDEN (integrated Digital Enhanced Network) or various other third generation networks such as EDGE (Enhanced Data rates for GSM Evolution), UMTS (Universal Mobile Telecommunications Systems), or Evolution-Data Optimized (EV-DO).

As shown in FIG. 2, the communications system 200 also includes a wireless network gateway 210 and one or more network provider systems 212, The wireless network gateway 210 provides translation and routing services between the network provider system(s) 212 and the WLAN 202, which facilitates communication between the wireless devices 102 and other devices (not shown) connected; directly or indirectly, to the network provider system 212,

The WLAN 204 comprises a network which in some examples conforms to IEEE 802.11 standards such as 802.11b and/or 802.11g; however, other communications protocols may also be used for the WLAN 204. The WLAN 204 includes one or more wireless RF Access Points (AP) 214 (one of which is shown in FIG. 2) that collectively provide a WLAN coverage area. For the embodiment depicted in FIG. 2, the WLAN 204 is operated by an enterprise (for example, a business or university in a building or campus type environment) and the access points 214 are connected to an access point (AP) interface 216. The AP interface 216 provides translation and routing services between the access points 214 and the network provider system 212 to facilitate communication between two or more of the wireless devices 102 and other devices (e.g., such as desktop computers) connected, directly or indirectly, to the network provider system 212. The AP interface 216 is implemented using a computer, for example, a server running a suitable computer program or software.

According to one embodiment, the other interfaces 206 may be implemented using a physical interface indicated by reference 218. The physical interface 218 includes an Ethernet, Universal Serial Bus (USB), Firewire, or infrared (IR) connection implemented to exchange information between the network provider system 212 and the wireless device 102.

The network provider system 212 comprises a server or server modules or a number of servers or server modules which are typically located behind a firewall (not shown). The network provider system 212 may include a number of modules including a mobile data delivery module 220. Various modules running on the network provider system 212 may be implemented as a number of services running on a single server or as a number of interconnected servers each running a software program to implement the functionality of the respective module. The network provider system 212 provides access or the wireless devices 102, through either the wireless WAN 202, the WLAN 204, or the other connection 206 to the devices connected, for example, through an enterprise network 224 (e.g., an intranet), to the network provider system 212. In one embodiment, the data delivery module 220 is implemented on a computer, such as the network provider system 212.

The enterprise network 224 comprises a local area network, an intranet, the Internet, a direct connection, or combinations thereof. The enterprise network 224 may comprise an intranet for a corporation or other type of organization. In at least some embodiments, the network provider system 212 is part of the enterprise network 224, and is located behind a corporate firewall and connected to the wireless network gateway 210 through the Internet. A computer 222 (e g., a desktop or laptop computer) belonging to the user of the wireless device 102 is typically connected to the enterprise network 224. As described earlier, the wireless device 102 may be temporarily and directly connected to the computer 222 using, for example, the serial port 152. Alternatively, the wireless device 102 may communicate with the computer 222 using the communication subsystem 112 and the WAN 202 and/or the short-range communications subsystem 162 and the WLAN 204.

As shown in FIG. 2, an application/content server 226 may be connected to the enterprise network 224 and also to another network, for example a Wide Area Network (WAN) 228. In some embodiments, an email server 232 and/or the content server 226 form part of the enterprise network 224. The WAN 228 may further connect to other networks The WAN 228 may comprise or be configured with the Internet, a direct connection, a LAN, a wireless communication link, or any combination thereof. Content providers, such as Web servers, may be connected to the WAN 228, an example of which is shown in FIG. 2 as an origin server 230.

According to one embodiment, the mobile data delivery module 220 provides connectivity between the wireless WAN 202 and the WLAN 204 and the other connection 206 and devices and/or networks connected directly or indirectly to the network provider system 212. In one embodiment, the connectivity provided may be Hypertext Transfer Protocol (HTTP) based connectivity providing an Internet based service connection to devices connected to the wireless WAN 202, the WLAN 204, or the other connection 206 and devices and/or networks connected directly or indirectly to the network provider system 212. The network 224, the application/content server 226, the WAN 228, and the origin server 230, are individually and/or collectivey in various combinations a content source for the network provider system 212. It will be appreciated that the system shown in FIG. 2 comprises but one possible communication network or configuration of a multitude of possible configurations for use with the wireless devices 102.

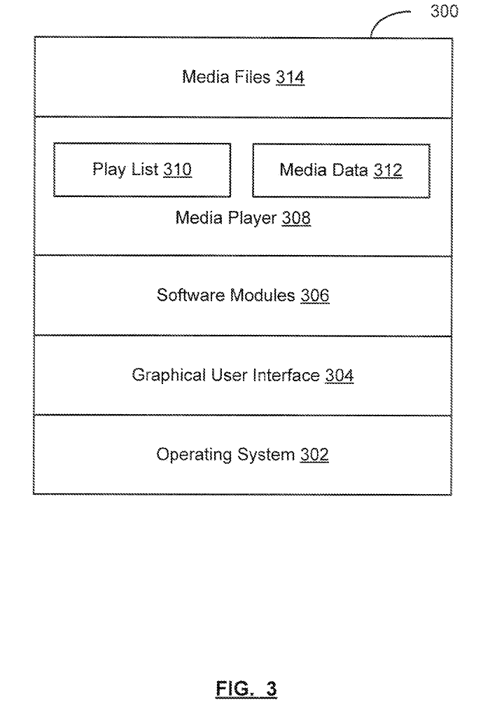

Reference is next made to FIG. 3, which shows a block diagram illustrating a memory 300 of the wireless device 102. The memory 300 has various software components for controlling the wireless device 102 and may include, for example, the flash memory 144, the RAM 146, the ROM 148, the memory module 130 and/or the other device subsystems 164. In accordance with one embodiment, the wireless device 102 is a portable media player intended to allow the user to listen to audio files and/or watch video files on the go. In accordance with another embodiment, the wireless device 102 is intended to be a multi-tasking wireless communications device configured for sending and receiving data items and for making and receiving voice calls that also includes a media player application enabling the user to listen to music and/or watch video files on the go. To provide a user-friendly environment to control the operation of the wireless device 102, an operating system (OS) 302 resident on the wireless device 102 provides a basic set of operations for supporting various applications typically operable through a graphical user interface (GUI) 304. For example, the operating system, 302 provides basic input/output system features to obtain input from the auxiliary I/O 150, the keypad 154, the clickable thumbwheel 160, and other input devices, and to facilitate output to the user via the display 142. The GUT 304 is typically a component of the operating system 302. One or more software modules 306 for managing communications or providing a personal, digital assistant (PDA) or other functions may also be included.

The memory 300 also includes an email and calendar client, which may be combined in, for example, a PIM application having email-based calendaring and scheduling functions. Typically, the PIM is installed as one of the software modules 306. The memory 300 also includes a media player application 308 for playing media files 314 that are stored in the memory 300. Typically, the media files 314 would be stored in the flash memory 144, but may be stored in any of the memory devices associated with the memory 300 such as removable memory cards, for example SD or mini-SD cards. The media player application 308 may further maintain in the memory 300 one or more play lists 310 and media data 312. In one embodiment, the play lists 310 are used by the media player application 308 to manage the playing of media selected from the media files 314, stored locally on the wireless device 102. The media data 312 may include any data about the media files 314 that the media player application 308 stores. Media may be available from an external source, for example media stored on the user's computer 222, that may be selected for copying to the wireless device 102 and for adding to and/or replacing the media files 314. The selection of available media from the computer 222 may also be stored as the media data 312. The media data 312 may also include metadata containing information about the media files 314.

Thus, the wireless device 102 includes computer executable programmed instructions for directing the wireless device 102 to implement various applications. The programmed instructions may be embodied in the one or more software modules 306 resident in the memory 300 of the wireless device 102. Alternatively, the programmed instructions may be tangibly embodied on a computer readable medium (such as a DVD, CD, floppy disk or other storage media) which may be used for transporting the programmed instructions to the memory 300 of the wireless device 102. Alternatively, the programmed instructions may be embedded in a computer-readable, signal-bearing medium, that is uploaded to the wireless network 104 by a vendor or supplier of the programmed instructions and this signal-bearing medium may be downloaded through one or more of the interfaces 112, 150, 152, 162 to the wireless device 102 from, for example, the wireless network 104 by end users.

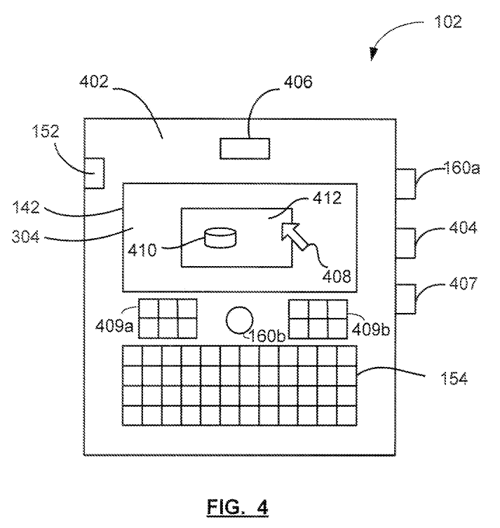

Reference is next made to FIG. 4, which shows a front view of the wireless device 102. As mentioned above, the wireless device 102 may be a data and voice-enabled handheld device. The wireless device 102 includes a casing 402, the data or serial port 152, the display screen 142, the graphical user interface (GUI) 304, the keypad 154, the clickable thumbwheel 160a or other device for navigation such as a trackball 160b, one or more input buttons 404 (e.g., select, cancel, talk, play, stop, fast forward, rewind, next, previous buttons), signal inputs/outputs 406 (e.g., power connector input, microphone, speaker, data Interface input, etc.), and an audio port 407. Additionally, the wireless device 102 may have a number of navigation control buttons 409a and 409b. The navigation control buttons 409 may provide a number of functions such as a send and/or end key for a mobile telephone application of the wireless device 102, a menu key, an escape key, etc. The functions of the navigation control buttons 409 may be user configurable Internally, the wireless device 102 includes one or more circuit boards (not shown) the microprocessor 140 (FIG. 1), the memory 300 (FIG. 3), the battery 138 (FIG. 1), the antennae 118, 120 (FIG. 1), etc,, which may all be coupled to the signal inputs/outputs 406, the keypad 154, the display screen 142, the clickable thumbwheel 160, etc.

The microprocessor 140 is typically coupled to one or more input devices (e.g., the buttons 404, the keypad 154, the clickable thumbwheel 160) for receiving user commands or queries and the display 142 for displaying the results or these commands or queries For example, user queries may be transformed into a combination of commands for producing one or more tables of output data which may be incorporated, in one or more display paces for presentation to the user. The microprocessor 140 is also coupled to the memory 300. The microprocessor 140 is typically coupled to a set of stereo headphones connected to either the audio port 407 or connected via a Bluetooth connection when the user wishes to use the media player application 308 to listen to audio files or watch video flies.

A user may interact with the wireless device 102 and its software modules 306 and the media player module 308 using the GUT 304. The. GUT 304 is controlled by the operating system 302 (FIG. 3) and provides a display format enabling the user to choose commands, execute application programs, manage computer files, and perform other functions by selecting pictorial representations (i.e., icons), or selecting items from a menu through the use of an input or pointing device such as the clickable thumbwheel 160 and/or the keypad 154. Generally, the GUI 304 is used to convey information and receive commands from users and generally includes a variety of GUT objects or controls including icons, toolbars, drop-down menus, pop-up menus, text, dialog boxes, buttons, etc. A user typically interacts with the GUT 304 presented on the display 142 by using an input or pointing device to position a pointer or cursor 408 over an object 410 (i.e., “pointing” at the object) and by “clicking” on the object 410 (e.g., by depressing the thumbwheel 160 or a button on the keyboard 154, etc.) This is often referred to as a point-and-click or selection operation. Typically, the object 410 may be highlighted (e.g., shaded) when it is selected or pointed at by the pointer or cursor 408 to indicate that the object 410 is selectable.

Typically, a GUI-based system presents application, status, and other information to the user in windows appearing on the display 142. A window 412 is a display area shown within the display 142, typically rectangular, in which a user may view an application or document. The window 412 may be open, closed, displayed full screen, reduced to an icon, increased or reduced in size, or moved to different areas of the display 142. Multiple windows 412 may be displayed simultaneously For example, the windows 412 may be displayed within other windows, overlapped with other windows, or tiled within the display area.

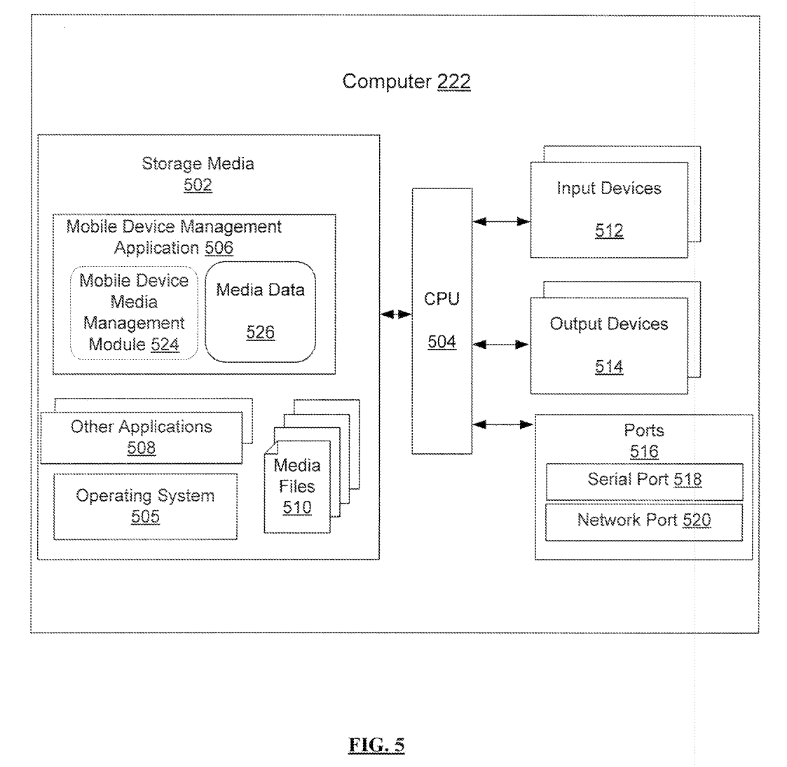

Reference is next made to FIG. 5, which is a block diagram illustrating an example of the computer 222, which includes one or more storage media 502 in communication with a central processing unit (CPU) 504. Although the storage media 502 is typically one or more hard-disk drives, the storage media 502 could additionally or alternatively include DVD media, CD media, flash memory, diskettes, RAM and/or other types of media. In some embodiments, various types of software are stored on the media 502 including an operating system 505, a mobile device management application 506 and other applications 508. Also stored on the media 502 are media files 510 and med data 526.

The computer 222 further includes one or more input devices 512, one or more output devices 514, and one or more communications subsystems or ports 516 in communication with the CPU 504, Examples of possible input devices include a mouse, keyboard, scanner, microphone, etc. Many of the input devices 512 may not be housed within the computer 222, but may instead provide input through one of the externally exposed ports 516. Examples of the possible output devices 514 include a monitor, a printer, speakers, etc. Many of the output devices 514 may not be housed within the computer 222 and, as such, output signals from the CPU 504 to one of the devices 514 may be transmitted through one of the ports 516. As will be appreciated by those skilled in the art, it is also possible that one or more of the devices 512 and 514 may be a device that is more accurately described as both an input and output device. In an example embodiment, the ports 516 include a serial port 518, such as a USB port, for example for supporting a wired connection to the serial port 152 of the wireless device 102 (FIG. 1) connected either directly or indirectly through a docking station (not shown). In one embodiment, the ports 516 also include a network port 520 for connecting to the network 224 (FIG. 2). The port 520 may comprise an Ethernet 10/100/1000 connector and/or a WLAN communications sub-system. A short-range wireless communications port or antenna may be included for supporting direct wireless communications such as 802.11b/g wireless networking, Bluetooth™, or infrared communications with either the wireless device 102 or the wireless network 104.

As indicated above, among the software applications on the computer 222 is a mobile device management application 506 (or suite of applications) which includes computer instructions that are executable by the CPU 504 of the computer 222 to implement, among other things, a portable device media management module 524 that facilitates the management of and transfer of media files from the computer 222 to the wireless device 102 that is associated with the computer 222. By way of example, the computer 222 and the wireless device 102 may be associated through a common user who has an assigned domain login ID and email account within the system 200. The wireless device 102 may be associated with the user domain ID and email account during activation. When a user logs onto a particular computer 222 using the domain login ID, both the computer 222 and the wireless device 102 are commonly associated with the user and hence each other. Association of the wireless device 102 with the computer 222 could also occur through other means, for example, when a user originally activates the wireless device 102, the wireless device 102 and the computer 222 may exchange IDs and/or addresses by being plugged directly together through a serial connection. In another example, the device may, upon activation, search for other devices through the short-range communications system 162 and present the user with a list of devices to “pair” with the wireless device 102 and the selected device (e.g., the computer 222) then authenticate each other via a password exchange, and, once paired, the associated devices remember the pairing and password so that future linking between the device is automatically performed.

The present application contemplates a number of features for improving the functionality of a media player application (e.g., the media player application 308) running on a wireless device (e.g., the wireless device 102). In one example, where the wireless device 102 has both media playing capabilities and voice capabilities such as cellular or mobile telephone capabilities, the media files 314 may include both music files and and ring tone files stored together as the media files 314. The music files and ring tone files may even share the same file type and file extension (e.g., .MP3 files). However, music files and ring tone files occupy different categories of media in the sense that they are treated differently in how they are played, displayed to the user, etc. Therefore, in one example, when the user uses the media player application 308 to view a list of all of the media files stored on the wireless device 102 (e.g., such as the media files 314), the media player application 308 does not show the user the ring tone files stored in the memory 300. This may be accomplished in a number of ways. For example, upon displaying the media files stored in the memory 300, the media player application may extract and examine metadata associated with each of the media files 314 to determine if each media file is a ring tone file Such metadata may be stored, for example, as ID3 tags within .MP3 files. Alternatively, such metadata may be stored as the media data 312 when the media files 314 are copied to the memory 300 of the wireless device 102. In yet another example, ring tones may be stored in a different directory or folder created in the memory 300, such as a specific “ring tone” directory, which is specifically excluded from audio lists by the media player application 308.

The media player application 308 may also be programmed to find all of the audio files in the memory 300 (e.g., in either the flash memory 144 or a mini-SD card inserted into the wireless device 102), regardless of which directories or folders the audio files reside in. For example, the media player application 308 may present to the user all audio files found on the wireless device 102, except for ring tone files. Conversely, when a user wishes to view only the ring tones found in the memory 300, for example while using a cellular telephone configuration application stored as one of the software modules 306, the application may display to the user only the ring tone files that are found. Again, the configuration application may identify ring tones based on metadata stored within the ring tone files, metadata stored as the media data 312, or based on the location of the ring tone files in a “ring tone specific” directory,

With the current memory limitations found in typical wireless devices such as the wireless device 102, it is often not feasible to carry around a significant amount of video stored in the memory 300. As such, introducing a folder structure into the media player application 308 for organizing video file stored as the media files 308 would be overkill for relatively simple operations that work a relatively small list of files. Therefore, the media player application 308 may provide the functionality to scour the memory 300 for all of the media files 314 that are video files. This may be determined in a number of ways, such as by examining metadata associated with the video files (e.g., either within the video files or saved as the media data 312) or simply by examining the file extensions or directly or folder placements of the video files. Any and all video files that are found are displayed in a video files example, the video list may have a flat hierarchy that aims to show all videos on a single list that is scrollable, if the list is longer than the display 142,

Users of the computer 222 may use the mobile device media management module 524 of the mobile device management application 506 to manage the media files 314 and associated play list 310 of the wireless device 102. The media management module 524 may offer the ability to create a play list and transfer the play list to the wireless device 102 (e,g., to be saved as the play list 310). The media player application 308 may search the memory 300 and find all play lists 310 that are available to the user of the wireless device 102, regardless of the specific location of the play list, 310 in the memory 300. In one example, play lists are most easily identifiable by a the extension (e.g., .m3u), but may also be identifiable by metadata stored either within the play list 310 file or saved as the media data 312. Play lists saved in the memory 300 may reference the media files 314 stored anywhere within the memory 300 Therefore, the play list 310 my reference the media files 314 stored in different directories or on different storage devices.

The media management module 524 that runs on the computer 222 is responsible for managing the play lists 310 of the media player application 308 that runs on the wireless device 102. This allows users to easily create and/or modify play lists on the computer 222 an transfer the play lists to the memory 300 of the wireless device 102. Naturally, a play list is not of much use without the media files to which the play list refers. Therefore the present application also contemplates that the media management module 524 automatically copies all media files associated with a play list to the memory 300 of the wireless device 102 when the play list is copied to the memory 300 and saved as the play list 310. This ensurses that users will not have to manually copy over each media file referenced by a newly created or edited play list, which may otherwise cause cumbersome referencing and pointer issues. Additionally, the present application contemplates an intelligent copying feature that aims to ensure two items. Firstly, media files that are transferred to the memory 300 along with the play list 310, are properly referenced in the play list 310 file (i.e., an .m3u file). In one example, the play list 310 .m3u file may be a text file comprising pointers to the associated media files 314. Secondly media files that are already resident in the memory 300 are not copied again from the storage media 502 of the computer 222 to the memory 300 if the media files are the same and have not changed. If a media file has been modified, for example to insert updated or more ID3 tag information, then the media file will be copied to the memory 300 again, thus overwriting the existing copy of the file in the memory 300. This feature has the potential to greatly reduce the amount of time required to synchronize the wireless device 102 with the computer 222 after any media management has been performed by the user using the media management module 524 of the computer 222.

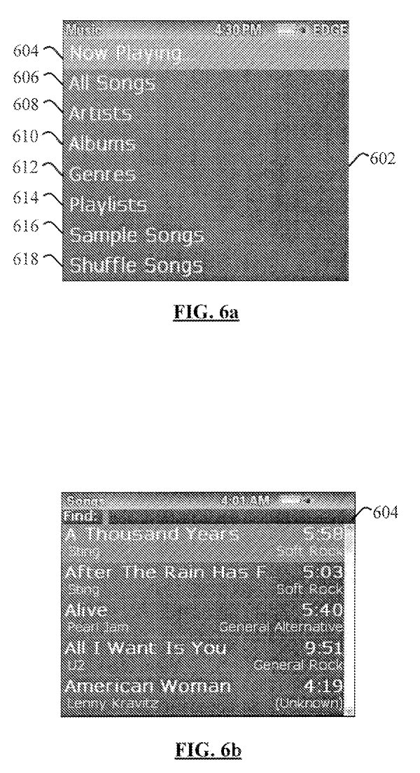

Reference is next made to FIGS. 6a and 6b, which show screen images of a media player application, for example the media player application 308 running on the wireless device 102, in accordance with one embodiment Referring to FIG. 6a, a menu 602 is shown. The menu 602 is available within the media player application 308 when the user chooses to view media files available for listening and/or viewing using the media player application 308. In one example, the media files are audio files stored as the media files 314 in the memory 300. The menu 602 presents the user with a number of options, which include: (a) Now Playing (604), which allows the user to view a listing of the audio file or files that are currently playing or are scheduled to be played if audio file(s) are currently playing; (b) All Songs (606), which allows the user to view a listing of all songs available on the wireless device 102 (e.g., in the memory 300 stored as the media files 314) for listening; (c) Artists (608), which allows the user to view a listing of the available audio files presented, organized and/or sorted by Artist name; (d) Albums (610), which allows the user to view a listing of the available audio files presented, organized, and/or sorted by the album to which the audio files belong; (e) Genres (612), which allows the user to view a listing of the available audio files presented, organized, and/or sorted according to the type of music to which the media files belong; (f) Playlists (614), which allows the user to view the play list 310 that are available in the media player application 308; (g) Sample Songs (616), which allows the user to view a listing of any sample songs that are saved as the audio, files 314 (e.g., sample songs are usually distributed with a new wireless device 102 and/or a new installation of the media player application 308 to demonstrate the capabilities of the device 102 and/or the application 308); and (h) Shuffle Songs (618) which simply allows the user to listen to all of the available audio files in a shuffled playback format.

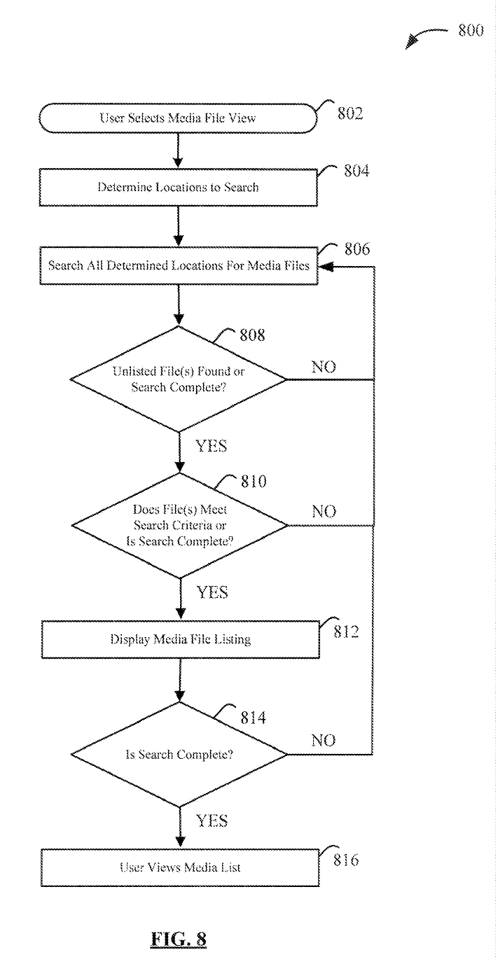

Referring to FIG. 6b, a menu 604 is shown, displaying a list of audio files that are available for listening. The menu 604 is shown to the user in response to the user choosing the “All Songs” option in the menu 602. The audio files displayed in the menu 604 are determined according to a method described below in connection with FIG. 8.

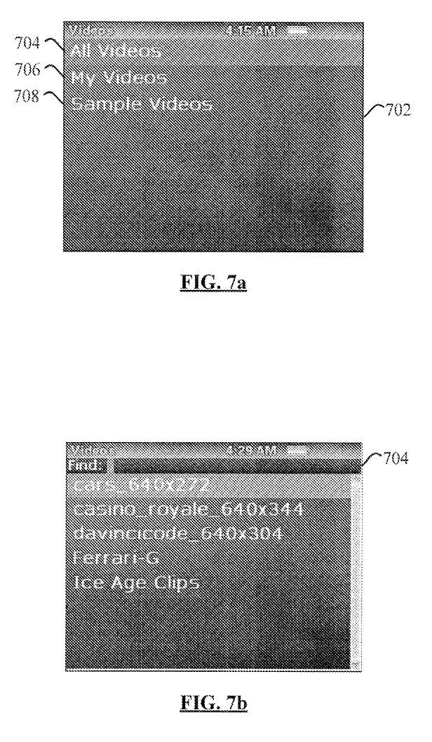

Reference is next made to FIGS. 7a and 7b, which show screen images of a media player application, for example the media player application 308 running on the wireless device 102, in accordance with one embodiment. Referring to FIG. 7a, a menu 702 is shown. The menu 702 is available within the media player application 308 when the user chooses to view media files available for listening and/or viewing using the media player application 308. In one example, the media files are video files stored as the media files 314 in the memory 300. The menu 602 presents the user with a number of options, which include. (a) All Videos (704), which allows the user to view a listing of all videos available on the wireless device 102 (e.g., in the memory 300 stored as the media files 314) for viewing and/or listening; (b) My Videos (706), which allows the user to view a listing of all videos available on the wireless device 102 that have, for example, been recorded by the user of the wireless device 102 using n integrated camera in the wireless device 102; and (c) Sample Videos (708), which allows the user to view a listing of any sample videos that are saved as the media files 314. For example, sample videos are usually distributed with a new wireless device 102 or a new installation of the media player application 308 to demonstrate the capabilities of the device 102 and/or the application 308. The menu 702 presents the user with less options than the menu 704 because video files typically require much larger amounts of storage space than audio files and therefore each occupy much larger portions of the memory 300 on the wireless device 102. As a result, the wireless device 102 is likely to have few videos stored in the memory 300. Therefore, a substantial management and/or navigational, menu system is not needed to manage video files, as opposed to audio files that are typically numerous and the user benefits from the more substantial menu system shown in connection with FIG. 6a.

Referring to FIG. 7b, a menu 704 is shown displaying a list of video files that are available for viewing and/or listening. The menu 704 is shown to the user in response to the user choosing the “All Videos” option in the menu 702. The video files displayed in the menu 704 are determined according to a method described next in connection with FIG. 8.

Reference is next made to FIG. 8, which shows a flow chart illustrating a method 800 for displaying media files in accordance with one embodiment, The method 800 is typically executed by the media player application 308 running on the microprocessor 140 of the wireless device 102 in response to the user selecting an option such as the “All Songs” 606 option shown in the menu 602 of FIG. 6a or the “All Videos” 704 option shown in the menu 702 of FIG. 7a. Method 800 provides for displaying to the user all of the media files 314 of a desired type stored in the memory 300 of the wireless device 102, regardless of different storage locations of the media files 314, such as in the flash memory 144, the RAM 146, the ROM 148, the memory module 130, or on a SD or micro-SD card inserted into the wireless device 102. The method 800 also presents to the user all of the media files 314 of a desired type, excluding files that the user would typically not wish to have included in the list (e.g., the listing shown as the listing 604 in FIG. 6b or the listing shown as the listing 704 in FIG. 7b). For example, a user who wishes to see a listing of all songs or videos available in the memory 300 would typically not want to see sample songs or sample videos that were included with the media player application 308 for demonstration purposes. In another example, a user who wishes to see a listing of all songs available in the memory 300 would typically not want to see ring tones that are saved in the memory 300 and are associated with a cellular telephone aspect of the wireless device 102.

A first step 802 of the method 800 simply indicates that the user has invoked the method 800 by selecting a media file view by choosing an option such as the “All Songs” 606 option shown in the menu 602 of FIG. 6a or the “All Videos” 704 option shown in the menu 702 of FIG. 7a. The method 800 next proceeds to a step 804, where the media player application 308 determines the appropriate locations to search for the desired or suitable media files. Typically, the appropriate locations are all storage media associated with the memory 300, but may exclude certain directories or folders intended for specific types of media files not to be included in the listing. For example, sample songs, sample videos, or sample pictures may be placed in a specific folder in the memory 300, perhaps entitled “sample videos”, “sample songs”, “sample files”, “sample media”, “sample pictures”, etc. These directories may be specifically excluded from the search. Likewise, ring tones may be placed in a “ring tone” directory, which may also be specifically excluded from the search. The directories or folders to be excluded by the search are typically set by default by the media player application 308. However, the media player application 308 may also allow the user to configure which directories or folders are to be excluded for the “all videos” or “all songs” searches.

Next, at a step 806, the media player application 308 searches the media files 314 located in the memory 300 excluding the folders or locations specifically determined to be excluded in the step 804. The search includes all storage locations associated with the memory 300, regardless of different locations of the media files 314, such as in the flash memory 144, the RAM 146, the ROM 148, the memory module 130, or on a SD or micro-SD card inserted into the wireless device 102. During the search, certain criteria are applied to determine whether files meet the criteria to be included in the listing of media files found, which is illustrated by steps 808 and 810. The search continues finding unlisted files until the search is complete, as illustrated by the step 808. As new unlisted files are found, the files are examined against defined criteria, as shown by the step 810. The criteria may be defined in numerous ways based upon file or media characteristics. For example, the media player application 308 searches based on file extensions to determine whether a file that is located is of the type that meets the criteria of the search. For example, the audio file related search launched by the “All Songs” 606 selection of the menu 602 may search for songs that have file extensions that are playable by the media player application 308, such as, for example .MP2, .MP3, .MP4, MC, and/or .WAV files.

In another example, the video file related search launched by the “All Videos” 704 selection of the menu 702 may search for videos that have file extensions that are playable by the media player application 308 such as, for example .VOB, .AVI, .WMV, and/or .MPG files. In another example, the media player application 308 may apply broader search strategies than simply using file extensions, for example where a file has an appropriate or unknown extension or does not have an extension and the media player application 308 may search any metadata contained within the files that are located (for example, metadata contained as ID3 tags in .MP3 files). In another example, the media player application 308 makes use of any metadata that is stored as the media data 312 in the memory 300 and/or play list information stored as the play list 310 in examining the media files 314 to determine which files meet the criteria for inclusion on the listing. After examining files that have been located in the search, media files that are determined to meet the criteria are identified as suitable media files. The suitable media files are then displayed in a menu at a step 812 (e.g., as shown in either the menu 604 of FIG. 6b or the menu 704 of FIG. 7b). Once the search is complete, as determined at a step 814, the method 800 is terminated at a step 816 where the user views the resulting media file list. If it is determined that the file being examined does not meet the required criteria at the step 810 or that the search is not complete at the step 814, the method continues searching at the step 806.

The result of the method 800 is that the media player application 308 displays to the user all of the media files 314 of a desired type (e.g., either video audio files, or picture files) stored in the memory 300 of the wireless device 102, regardless of different storage locations of the media files 314, such as in the flash memory 144, the RAM 146, the ROM 148, the memory module 130, or on a SD or micro-SD card inserted into the wireless device 102. Files that the user would typically not wish to have included in the list such as sample songs, ring tones, or sample pictures are excluded. The exclusions and/or inclusions may be decided according to the numerous approaches described above, or based on any other approaches known to those skilled in the art. While the method 800 is applied to the example of audio and video flies, those skilled in the art will recognize that the method 800 is equally applicable to other types of media files such as picture, image, or photo files.

While the steps of the method 800 are shown as occurring in a particular order, it will be appreciated by those skilled in the art that many of the steps are interchangeable and may occur in different orders than that shown without materially affecting the end results of the method 800. Additionally, while the execution of method 800 is described as principally occurring within the wireless device 102 media player application 308, it will be understood by those skilled In the art that a similar method may be implemented in the mobile device management application 506 of the computer 222.

The method 800 also provides a number of additional features at the step 812 where the media file listing is shown as the results of the search after the search has been completed. The results of the search may be shown to the user in a way that differentiates the search results for the user of the wireless device 102. In one example, the individually listed media files shown within the media file listing may be sorted by group(s), such as by artist, album, genre, etc. In another example, media file listings may differentiate between groups of files listed within the listing or between individual files of the listing using different icons displayed next to one or more of the items, or different colours, shades, or light intensities of fonts, borders, or highlighting, etc. For example, the media file listing shown in FIG. 6b could use one font colour to display soft rock titles, another font colour to display general alternative titles, and a third colour to display general rock titles. Alternatively, soft rock titles may be highlighted or shown in a brighter font in response to a number of possible conditions, such as the user having indicated in the media player application 308 that he prefers soft rock titles. In another example, instead of displaying the media files alphabetically, as shown in FIG. 6b, the media files may be grouped and listed according to genre, with all soft rock titles appearing at the top of the list. In yet, another example, different icons may appear next to individual files listed in the media file listing shown in FIG. 6b, with one icon appearing next to soft rock titles, another icon appearing next to general alternative titles, etc.

In yet another example, a media file listing such as the listing 604 shown in FIG. 6b may be displayed in response to the user performing a media file search. For example, the user may perform a search for all media files of the soft rock genre. The media player application 308 may then display the results of the search in a media file listing, such as the listing 604. The media file listing may sort the results to show the most relevant search results at the top of the listing (e.g., soft rock selections are shown at the top, with less relevant alternative and general rock media files shown below). Additionally, the media file listing may show an indicator next to each of the media files shown in the listing 604, such as a relevance indicator such as a percentage (e.g., soft rock titles are shown as 100% relevant) or using different colours or shades, in one example, soft rock titles may be shown using a first colour such as green font or highlighting to indicate a 100% relevancy to the search criteria, while general alternative titles may be shown using a different colour such as yellow to indicate a lower level of relevancy (e.g., 80%).

While the present disclosure is primarily described as a method, a person of ordinary skill in the art will understand that the present disclosure is also directed to an apparatus for carrying out the disclosed method and including apparatus parts for performing each described method step, be it by way of hardware components, a computer programmed by appropriate software to enable the practice of the disclosed method, by any combination of the two, or in any other manner Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the disclosed method. It is understood that such apparatus, articles of manufacture, and computer data signals also come within the scope of the present disclosure.

The embodiments of the present disclosure described above are intended to be examples only. Those of skill in the art may effect alterations, modifications and variations to the particular embodiments without departing from the intended scope of the present disclosure. In particular, selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

1. A method for use with a media application running on a wireless device, the method for displaying to a user a listing of media files available in a memory of the wireless device, the method comprising the steps of:
determining locations in the memory to search for the available media files, the locations including all memory devices of the wireless device suitable for storing the media files excluding one or more predetermined folders contained in the memory;
searching the determined locations for files to include in the listing of available media files;
locating files not already included in the listing of available media files;
determining if the located files meet one or more defined criteria of the search and identifying the located files that meet the defined criteria of the search as suitable media files; and
displaying a menu listing the available media files

2. The method according to claim 1, wherein the one or more predetermined folders contained in the memory are folders for storing media files that are excluded from the listing of media files for use with the media application.

3. The method according to claim 2, wherein the one or more predetermined folders includes a folder for storing sample media files.

4. The method according to claim 2, wherein the one or more predetermined folders includes a folder for storing ring tone media files.

5. The method according to claim 1, wherein all memory devices of the wireless device include at least one of a read-only memory (ROM), a random access memory (RAM), a FLASH memory, and one or more removable memory cards.

6. The method according to claim 1, wherein all memory devices of the wireless device include at least two of a read-only memory (ROM), a random access memory (RAM), a FLASH memory, and one or more removable memory cards, the one or more removable memory cards including Secure Digital (SD) removable memory cards.

7. The method according to claim 6, wherein the SD removable memory card is a mini-SD card.

8. The method according to claim 1, wherein the step of determining if the located files meet criteria of the search includes examining metadata associated with the files.

9. The method according to claim 8, wherein the metadata is stored within the files.

10. The method according to claim 8, wherein the metadata is stored separately in the memory of the wireless device as media data.

11. The method according to claim 1, wherein the one or more predetermined folders are configurable by the user of the wireless device.

12. The method according to claim 1, wherein the suitable media files are selected from the group consisting of video files, image files, and audio files, the criteria requiring the suitable media files to be selected from the group consisting of video files, image files, and audio files.

13. A wireless device for displaying to a user a listing of media files available in a memory of the wireless device, the wireless device comprising:
a microprocessor for controlling operation of the wireless device;
a first input device coupled to the microprocessor for accepting an input from a user of the wireless device,
a display device coupled to the microprocessor for communicating an output to the user;
a communications subsystem coupled to the microprocessor for communicating with a communications network; and
a memory coupled to the microprocessor;
the wireless device including a media application module resident in the memory for execution by the microprocessor, the memory having media files stored therein, the media application module being configured to:
determine locations in the memory to search for the available media files, the locations including all memory devices of the wireless device suitable for storing the media flies excluding one or more predetermined folders contained in the memory;
search the determined locations for files to include in the listing of variable media files;
locate files not yet included in the listing of available media files;
determine if the located files meet criteria of the search and identifying located files that meet the one or more defined criteria of the search as suitable media files; and
display a menu listing the available media files.

14. The system according to claim 13, wherein the one or more predetermined folders contained in the memory are folders for storing media files that are to be excluded from the listing of media files for use with the media application.

15. The system according to claim 14, wherein the one or more predetermined folders include at least one of a folder for storing sample media files and a folder for storing ring tone media files.

16. The system according to claim 13, wherein the memory of the wireless device includes at least one of a read-only memory (ROM), a random access memory (RAM), a FLASH memory, and one or more removable memory cards.

17. The system according to claim 13, wherein the memory of the wireless device includes at least two of a read-only memory (ROM), a random access memory (RAM), a FLASH memory, and one or more removable memory cards, the one or more removable memory cards including Secure Digital (SD) removable memory cards.

18. The system according to claim 13, wherein the media application module being configured to determine if the located media files meet criteria of the search includes examining metadata associated with the media files.

19. The system according to claim 13, wherein the suitable media files are selected from, the group consisting of video files, image files, and audio files, the criteria requiring the suitable media files to be selected from the group consisting of video files, image files, and audio files.

20. A computer program product having a computer readable medium tangibly embodying code for displaying to a user a listing of media files available in a memory of a wireless device, the wireless device including a media applications running on the wireless device, the computer program product including:
code for determining locations in the memory to search for the available media files; the locations including all memory devices of the wireless device suitable for storing the media files excluding one or more predetermined folders contained in the memory;
code for searching the determined locations for files to include in the listing of available media files;
code for locating files not yet included in the listing of available media files;
code for determining if the located files meet criteria of the search and identifying located files that meet the criteria of the search as suitable media files; and
code for displaying a menu listing the available media files.
